(19) United States
(12) Patent Application Publication
(10) Pub. No.: US 2002/0135139 A1
(43) Pub. Date: Sep. 26, 2002

(54) Heat resistant and oil-resistant sealing member

(75) Inventors: Norio Tanaka, Handa-shi (JP); Masahiro Tomita, Obu-shi (JP); Shogo Oda, Gamagori-shi (JP)

Correspondence Address: Pillsbury Winthrop LLP, Intellectual Property Group, 1600 Tysons Boulevard, McLean, VA, 22102, US

(73) Assignee: NIPPONDENSO CO., LTD.

(21) Appl. No.: 10/115,085

(22) Filed: Apr. 4, 2002

Related U.S. Application Data
(63) Continuation of application No. 08/291,577, filed on Aug. 16, 1994, now abandoned.
Application No. 08/291,577 is a continuation of application No. 07/871,796, filed on Apr. 22, 1992, now abandoned.

(30) Foreign Application Priority Data
Apr. 25, 1991 (JP) 03-095781

(51) Int. Cl. F16J 15/08

(52) U.S. Cl. 277/650

(57) ABSTRACT

The invention relates to a heat resistant and oil resistant sealing member. The sealing member has a main body of acrylic rubber and a fixation-preventive layer made of silicone resin or rubber. The fixation-preventive layer prevents the main body from becoming affixed to an opposing member.

### BACKGROUND OF THE INVENTION

1. Field of the Invention

The present invention relates to a heat resistant and oil resistant sealing member for use on, for example, an oil filter.

2. Description of Related Art

Acrylonitrile-butadiene rubber (NBR) has been used as gasket material for oil filters because it has good oil-resistance. However, the performance improvement of engines in recent years has resulted in an elevation of the oil temperature, to which the oil filter is exposed. Furthermore, the position of the oil filter has changed which also results in a significant increase in the temperature the oil filter is exposed to. Oil filter gaskets made of NBR are used today at their temperature limit, and the demands of new engines exceeds this temperature limit.

Acrylic rubber is excellent in both heat resistance and oil resistance. However, acrylic rubber readily adheres to and becomes affixed to metallic materials, particularly ferrous materials such as cast iron and the like, at high temperatures, such as about 100° C. or above. Accordingly, if acrylic rubber is used as an oil filter gasket, the acrylic rubber adheres to and becomes affixed to the engine block, which results in fragments of acrylic rubber being left on the surface of engine block when the oil filter is changed.

Silicone rubber is also known as a material excellent in heat resistance and, therefore, has been used as an oil filter gasket. However, silicone rubber is inferior to acrylic rubber in oil resistance. Furthermore, silicone rubber has insufficient mechanical strength.

### SUMMARY OF THE INVENTION

The present invention solves the above-mentioned problems. An object of the present invention is to provide a sealing member which has excellent heat resistance and oil resistance, and which does not become affixed to metal at high temperatures

The heat resistant and oil resistant sealing member of the present invention comprises a main body of a sealing member made of acrylic rubber and a fixation-preventive layer for preventing the fixation of the main body of the sealing member onto an opposing member. The fixation-preventive layer is formed at least on the bonding surface of the main body of the sealing member to be contacted with the opposing member.

### BRIEF DESCRIPTION OF THE DRAWINGS

FIG. 1 is a partial sectional view illustrating the left half of an oil filter gasket according to the invention.

FIG. 2 is a partial sectional view illustrating the relationship between an oil filter gasket according to the invention, an oil filter and an engine block.

### DESCRIPTION OF PREFERRED EMBODIMENTS

The present invention is explained below referring to a specific embodiment, for example, an oil filter gasket and is in no way limited to such specific embodiment.

The heat resistant and oil resistant sealing member of the present invention comprises a main body of a sealing member made of acrylic rubber and a fixation-preventive layer for preventing the fixation of the main body of the sealing member onto an opposing member. The fixation-preventive layer is formed at least on the bonding surface of the main body of the sealing member to be contacted with the opposing member.

The shape of the main body of the sealing member is not critical.

The kind of acrylic rubber is not critical. However, a cryogenic type acrylic rubber excellent in low temperature characteristics is preferred.

The fixation-preventive layer prevents the acrylic rubber of the main body of the sealing member from becoming affixed to the surface of a metallic opposing member, and it is formed at least on a surface of the main body of the sealing member which is to be prevented from affixation to the opposing member.

The fixation-preventive layer preferably has a thickness of 3-35 μm. If the thickness of the fixation-preventive layer is less than 3 μm, it does not sufficiently prevent the acrylic rubber of the main body of the sealing member from becoming affixed to the surface of a metallic opposing member. If the thickness is greater than 35 μm, productivity of film formation is low.

The fixation-preventive layer can be formed as a film on the surface of the acrylic rubber of the main body of the sealing member.

The specific material of the fixation-preventive layer is not critical so long as it is not readily fixable onto a metallic member such as cast iron, aluminum alloy and the like, at high temperatures. For example, the fixation-preventive layer can be formed from silicone resin, silicone rubber and the like.

A fixation-preventive layer made of silicone resin or silicone rubber can be formed, for example, by coating a solution of silicone resin or silicone rubber onto a prescribed area of main body of a sealing member and firing it at a temperature of about 100-200° C. for about 5-30 minutes.

Examples of suitable silicone resins are represented by the following composition formulas, wherein n and m are each an integer of 1 or greater:

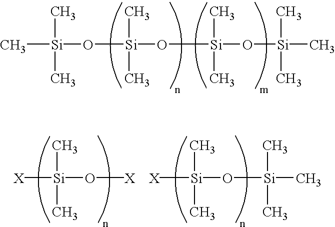

Examples of suitable silicone rubbers are represent by the following formula, wherein n is an integer of 1 or greater.

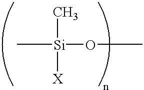

In the formulas presented above, X represents one member selected from the group consisting of silanol, hydrogen, alkoxy, amino, carboxyl, alcohol, epoxy, phenyl and the like.

Because the main body of the heat resistant and oil resistant sealing member of the present invention is an acrylic rubber, it has excellent heat resistance and oil resistance. Further, because the main body has a fixation-preventative layer formed on the surface to be contacted with an opposing member, the main body is prevented from direct contact with the opposing member so that affixation between the main body and the opposing member is prevented.

### EXAMPLES

The heat resistant and oil resistant sealing member of the present invention is explained by referring to examples of an oil filter gasket. The scope of the invention is in no way limited by these examples.

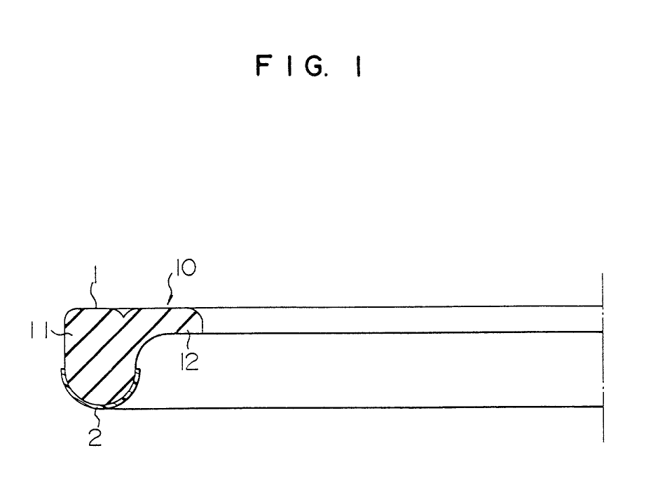

The oil filter gasket (10) of the present invention has a ring-like shape comprising a main body (1) and a fixation-preventive layer (2), as show in FIG. 1. The main body comprises a ring-like thick-gage seal part (11) compressed and held between the oil filter and engine block and a ring-like thin-gage holder part (12) integrally and horizontally extending from the upper part of the inner periphery of seal part (11). The fixation-preventive layer (2) is a coating layer continuously covering the whole lower surface of the seal part (11) and the upper part of the lateral surface of the seal part (11). The holder part (12) of the main body of gasket (1) is held by nails of the oil filter. The upside surface of main body of gasket (1) is contacted with the oil filter, and the fixation-preventive layer (2) formed on the downside surface of seal part (11) is contacted with engine block.

The main body of gasket (1) was made of a cryogenic type acrylic rubber.

The fixation-preventive layer (2) was made of a silicone resin and was formed in the following manner. First, a silicone resin represented by the following composition formula, wherein n is an integer of 1 or greater, was dissolved into a solvent (toluene), and a silane coupler or the like was added thereto as a reaction catalyst to prepare a solution.

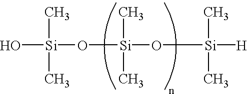

While rotating the main body of gasket (1), the solution was sprayed thereon from a nozzle, by which a prescribed area of the seal part (11) of the main body of gasket (1) was coated with the solution. Then, the seal part (11) having the coating thereon was fired at 175° C. for 10 minutes, whereby the silicone resin and the acrylic rubber were condensed with each other to form a fixation-preventive layer (2) having a thickness of 5 μm on the prescribed area of seal part (11) of the main body of gasket (1).

Since the main body of gasket (1) is formed of an acrylic rubber, the gasket (10) of this example had excellent heat resistance and oil resistance.

Further, since a fixation-preventive layer (2) comprising a silicone resin is formed on the surface of the main body to be contacted with the engine block, the acrylic rubber is prevented from coming into a direct contact with the engine block and the affixation of the acrylic rubber to the engine block is prevented.

In the gasket (10) of this example, the fixation-preventive layer (2) is formed only on the surface between the main body of gasket (1) and the engine block, and no fixation-preventive layer is formed on the surface contacting the oil filter. Accordingly, gasket (10) is prevented from affixation to engine block and is readily fixable onto the oil filter. For this reason, at the time of changing the oil filter the gasket (10) can easily be released from the engine block while the gasket (10) is affixed onto the oil filter without leaving any fragments of the acrylic rubber of the main body of gasket (1) on the engine block.

Further, since the acrylic rubber of the main body of gasket (1) and the silicone resin comprising the fixation-preventive layer (2) are chemically bonded to each other by a condensation reaction, the release between the main body of gasket (1) and the fixation-preventive layer (2) is also prevented.

### Evaluation of Examples

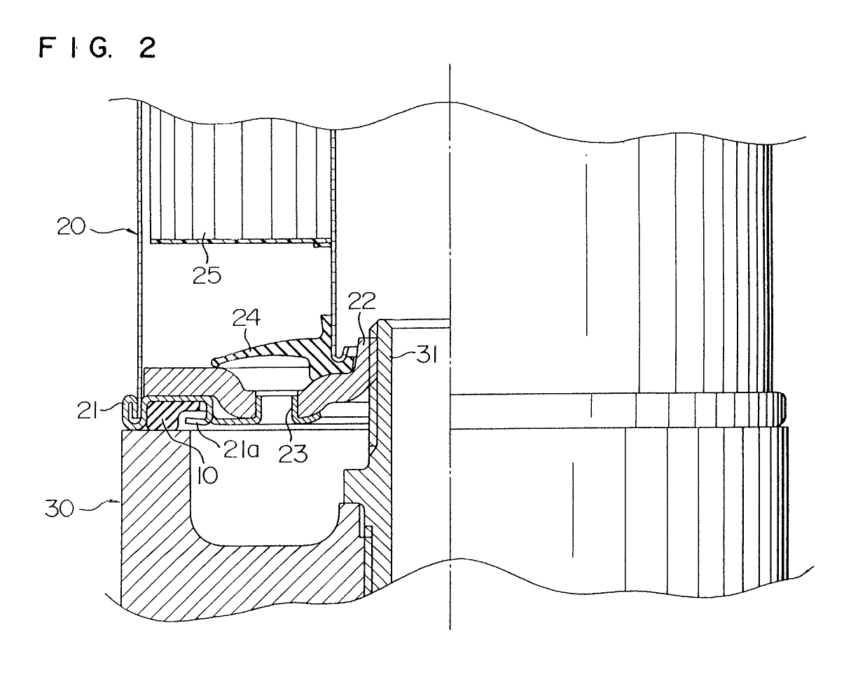

An oil filter (20) to which an oil filter gasket (10) of the above-presented example had been attached, as shown in FIG. 2, was fitted onto an engine block (30) of a car. The car was then made to run with a monitor for a distance of 20,000 to 25,000 km, after which the force of fixation between gasket (10) and engine block (30) was measured. The measurement was carried out by pulling the gasket (10) by means of a spring balance and measuring the maximum load (g) required for releasing gasket (10) from engine block (30) as a force of fixation.

The measurements were conducted on nine gasket samples having the same composition. The results obtained are summarized in Table 1 as sample numbers 1-9.

For comparison, four comparative gaskets having the same composition as samples 1-9 except that no fixation-preventive layer 2 was formed were similarly examined for force of fixation. The results are shown in Table 1 as sample numbers 10-13.

As shown in FIG. 2, gasket (10) is held by the nails (21a) formed on the iron bottom surface (21) comprising oil filter (20). The oil filter (20) is provided with a central exhaust slot (22) screwed in the central cylinder part (31) of the engine block (30) made of cast iron, a sucking inlet (23) sucking the oil from the engine block (30), a valve member (24) made of rubber preventing the back flow of oil from the sucking inlet (23), and a filter (25) for cleaning the oil. The oil having been cleaned by filter (25) passes through the inner space of the central cylinder part (31) and is sent to the engine block (30).

TABLE 1

| | | | | | | | | | | | | | |
|---|---|---|---|---|---|---|---|---|---|---|---|---|---|
| Sample No. | 1 | 2 | 3 | 4 | 5 | 6 | 7 | 8 | 9 | 10 | 11 | 12 | 13 |
| Force of fixation | 0 | 0 | 5 | 5 | 10 | 10 | 20 | 30 | 40 | 290 | 390 | 420 | 440 |

It is apparent from Table 1 that the gasket of the present invention (10) in which a fixation-preventive layer (2 )made of silicone resin is formed on the surface facing engine block (30) has a significantly reduced fixation force onto the engine block (30) compared with the conventional gaskets of comparative examples 10-13 in which no fixation-preventive layer was formed.

When the main body of gasket 1 was formed of other acrylic rubbers or when the fixation-preventive layer (2) was formed of other silicone resins or silicone rubbers, the results obtained were comparative to those shown above.

A fixation-preventive layer made of a silicone resin or a silicone rubber exhibits a fixation-preventive effect on an opposing member made of cast iron shown above but also to non-ferrous opposing members made of, for example, aluminum alloy or the like.

In the examples presented above, the heat resistant and oil resistant sealing member of the present invention was applied to an oil filter gasket. However, the heat resistant and oil resistant member of the present invention is also applicable to other members which must be resistant to heat and oil, and which must be resistant to adhering to an opposing member, such as, for example, an O ring used on piping in an engine room requiring maintenance, and the like.

As detailed above, the heat resistant and oil resistant sealing member of the present invention has excellent heat resistance and oil resistance and exhibits a high mechanical strength because the main body is formed of an acrylic rubber. The main body of the heat resistant and oil resistant sealing member of the present invention is prevented from fixation onto opposing members because a fixation-preventive layer is formed on a prescribed area of the main body of the sealing member.

Accordingly, the heat resistant and oil resistant sealing member of the invention can be used with high reliability in a position where heat resistance and oil resistance are required and where the fixation of rubber to an opposing member is to be prevented.

While the present invention has been described in detail and with reference to specific embodiments thereof, it is apparent to one of ordinary skill in the art that various changes and modifications can be made therein without departing from the spirit and scope thereof.

What is claimed is:

1. A heat-resistant and oil-resistant sealing member comprising:
a main body and a fixation-preventive layer, said main body being made of an acrylic rubber, and said fixation-preventive layer formed on said body being at least on the surface of said body facing an opponent member to prevent said sealing member from fixing to said opponent member.

2. A heat-resistant and oil-resistant sealing member according to claim 1, wherein said fixation-preventive layer has a thickness of 3-35 μm.

3. A heat-resistant and oil-resistant sealing member according to claim 1, wherein said fixation-preventive layer is made of a silicone resin.

4. A heat-resistant and oil-resistant sealing member according to claim 1, wherein said fixation-preventive layer is made of a silicone resin represented by one of the following formulas: 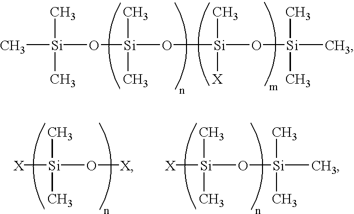
wherein n and m are each an integer of 1 or greater and X represents one member selected from the group consisting of silanol, hydrogen, alkoxy, amino, carboxyl, alcohol, epoxy and phenyl.

5. A heat-resistant and oil-resistant sealing member according to claim 1, wherein said fixation-preventive layer is made of a silicone rubber.

6. A heat-resistant and oil-resistant sealing member according to claim 1, wherein said fixation-preventive layer is made of a silicone rubber represented by the following formula: 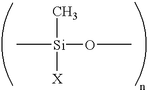
wherein n is an integer of 1 or greater and X represents one selected from the group consisting of silanol, hydrogen, alkoxy, amino, carboxyl, alcohol epoxy and phenyl.

7. A heat-resistant and oil-resistant sealing member according to claim 1, wherein said fixation-preventive layer is formed only on the surface facing the opponent member.

8. A heat-resistant and oil-resistant sealing member according to claim 1, wherein said fixation-preventive layer is chemically bonded to an acrylic rubber.

9. A heat-resistant and oil-resistant sealing member according to claim 1 for use as an oil filter.
